(19) United States
(12) Patent Application Publication
(10) Pub. No.: US 2017/0329261 A1
(43) Pub. Date: Nov. 16, 2017

(54) ELECTROSTATIC PRINTING APPARATUS AND INTERMEDIATE TRANSFER MEMBERS

(71) Applicant: Hewlett-Packard Indigo B.V., Amstelveen (NL)

(72) Inventors: Wael Salalha, Bet Jan (IL); Regina Guslitzer, Nes Ziona (IL); Tali Aqua, Nes Ziona (IL); Dina Voloshin Firouz, Nes Ziona (IL); Sergey Inotaev, Nes Ziona (IL)

(21) Appl. No.: 15/521,879

(22) PCT Filed: Oct. 31, 2014
(86) PCT No.: PCT/EP2014/073503

§ 371 Date: Apr. 25, 2017

(51) Int. Cl. G03G 15/16; G03G 15/01

(52) U.S. Cl. CPC G03G 15/162; G03G 15/1685; G03G 15/0163; G03G 2215/0626

(57) ABSTRACT

Herein is disclosed an electrostatic printing apparatus comprising: a photoconductive member having a surface on which can be created a latent electrostatic image; an intermediate transfer member comprising: a supportive portion; and an outer release layer disposed on the supportive portion comprising a base polymer matrix and an additive selected from carbon nanotubes and carbon black nanoparticles. The carbon black nanoparticles have a BET surface area of 700 m²/g or greater, the additive is dispersed in the base polymer matrix, and the base polymer is a silicone polymer. The electrostatic printing apparatus is adapted, in use, on contacting the surface of the photoconductive member with an electrostatic ink composition to form a developed toner image on the surface of the latent electrostatic image, then transfer the developed toner image to the outer release layer of intermediate transfer member, and then transfer the developed toner image from the outer release layer of the intermediate transfer member to a print substrate.

Electrostatic printing processes typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, in some examples, by being first transferred to an intermediate transfer member, which can be a soft swelling blanket, and then to the print substrate.

### BRIEF DESCRIPTION OF THE FIGURES

FIG. 1 is a schematic illustration an example of a Liquid Electro Photographic (LEP) printing apparatus.

FIG. 2 is a cross-sectional diagram of an example of an intermediate transfer member (ITM).

FIG. 3 is a cross-sectional diagram of an example of an ITM.

FIG. 4a shows a Zygo image of an example of a release layer swelled in isopar oil.

FIG. 4b shows a Zygo image of an example of a release layer containing 0.5 wt % carbon nanotubes and swelled in isopar oil.

FIG. 4c shows a Zygo image of an example of a release layer containing 1.0 wt % carbon black nanoparticles and swelled in isopar oil.

FIG. 5 is a line graph which illustrates the surface roughness of an example of a release layer containing 0.5 wt % carbon nanotubes and swelled in isopar oil.

### DETAILED DESCRIPTION

Before the electrostatic printing apparatus, intermediate transfer members and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “electrostatic ink composition” generally refers to an ink composition that is typically suitable for use in an electrostatic printing process, sometimes termed an electrophotographic printing process. The electrostatic ink composition may include chargeable particles of the resin and the pigment dispersed in a liquid carrier, which may be as described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly, or indirectly via an intermediate transfer member, to a print substrate. As such, the image is not substantially absorbed into the photo imaging substrate on which it is applied.

Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, the term “at least some of the” is used to mean at least 10 wt %, in some examples at least 20 wt %, in some examples at least 30 wt %, in some examples at least 40 wt %, in some examples at least 50 wt %, in some examples at least 60 wt %, in some examples at least 70 wt %, in some examples at least 75 wt %, in some examples at least 80 wt %, in some examples at least 85 wt %, in some examples at least 90 wt %, in some examples at least 95 wt %, of the component referred to.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Sizes, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range.

Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided an intermediate transfer member (ITM) having a supportive portion and an outer release layer disposed on the supportive portion. The outer release layer comprising a base polymer matrix and an additive dispersed in the base polymer matrix. The additive selected from carbon black nanotubes and carbon black nanoparticles.

Also provided is a pre-cure release composition comprising at least one silicone oil; and an additive selected from carbon black nanotubes and carbon black nanoparticles. In some examples, there is provided a pre-cure release composition comprising at least one silicone oil; a cross-linker comprising a silicon hydride component; and an additive selected from carbon black nanotubes and carbon black nanoparticles.

In an aspect there is provided an electrostatic printing apparatus. The electrostatic printing apparatus may comprise:
a photoconductive member having a surface on which can be created an latent electrostatic image;
an intermediate transfer member comprising:
a supportive portion; and
an outer release layer disposed on the supportive portion comprising a base polymer matrix and an additive selected from carbon nanotubes and carbon black nanoparticles, the carbon black nanoparticles having a BET surface area of 700 m²/g or greater, the additive being dispersed in the base polymer matrix, and the base polymer being a silicone polymer; wherein the electrostatic printing apparatus is adapted, in use, on contacting the surface of the photoconductive member with an electrostatic ink composition to form a developed toner image on the surface of the latent electrostatic image, then transfer the developed toner image to the outer release layer of intermediate transfer member, and then transfer the developed toner image from the outer release layer of the intermediate transfer member to a print substrate.

In an aspect, there is also provided an intermediate transfer member for use in an electrostatic printing process. The intermediate transfer member may comprise: a supportive portion; and an outer release layer disposed on the supportive portion. The outer release layer comprising a base polymer matrix and an additive selected from carbon nanotubes and carbon black nanoparticles, the carbon black nanoparticles having a BET surface area of 700 m²/g or greater, wherein the additive is dispersed in the base polymer matrix, the base polymer is a silicone polymer.

In an aspect, there is also provided a pre-cure release layer composition. The pre-cure release composition may comprise:
at least one silicone oil;
a cross-linker; and
an additive selected from carbon nanotubes and carbon black nanoparticles having a BET surface area of 700 m²/g or greater.

In some examples, the pre-cure release composition may comprise:
at least one silicone oil having alkene groups linked to the silicone chain of the silicone oil;
a cross-linker comprising a silicon hydride component; and
an additive selected from carbon nanotubes and carbon black nanoparticles having a BET surface area of 700 m²/g or greater.

In some examples, the carbon nanotubes comprise single-walled carbon nanotubes (SWCNT).

In some examples, the carbon nanotubes comprise multi-walled carbon nanotubes (MWCNT).

In some examples, at least some of the carbon nanotubes have a diameter of greater than about 0.5 nm, in some examples greater than about 1 nm, in some examples greater than about 2 nm, in some examples greater than about 3 nm, in some examples greater than about 4 nm, in some examples greater than about 5 nm, in some examples greater than about 6 nm, in some examples greater than about 7 nm, in some examples greater than about 8 nm, in some examples greater than about 9 nm.

In some examples, at least some of the carbon nanotubes have a diameter of less than about 100 nm, in some examples less than about 50 nm, in some examples less than about 40 nm, in some examples less than about 30 nm, in some examples less than about 25 nm, in some examples less than about 20 nm.

In some examples, at least some of the carbon nanotubes have a diameter from about 0.5 nm to about 50 nm, in some examples from about 1 nm to about 25 nm, in some examples from about 5 nm to about 20 nm.

The diameter of a carbon nanotube may be determined using high resolution transmission electron microscopy.

In some examples, the average diameter of the carbon nanotubes added to the release layer is greater than about 0.5 nm, in some examples greater than about 1 nm, in some examples greater than about 2 nm, in some examples greater than about 3 nm, in some examples greater than about 4 nm, in some examples greater than about 5 nm, in some examples greater than about 6 nm, in some examples greater than about 7 nm, in some examples greater than about 8 nm, in some examples greater than about 9 nm.

In some examples, the average diameter of the carbon nanotubes added to the release layer is less than about 100 nm, in some examples less than about 50 nm, in some examples less than about 40 nm, in some examples less than about 30 nm, in some examples less than about 25 nm, in some examples less than about 20 nm.

In some examples, the average diameter of the carbon nanotubes added to the release layer is from about 0.5 nm to about 50 nm, in some examples from about 1 nm to about 25 nm, in some examples from about 5 nm to about 20 nm.

The average diameter of carbon nanotubes may be determined using high resolution transmission electron microscopy. For example, the average diameter may be a number average diameter, or the Gaussian mean diameter. The Gaussian mean diameter may be determined as described by Ren et al., in “Morphology, diameter distribution and Raman scattering measurements of double-walled carbon nanotubes synthesized by catalytic decomposition of methane, Chem Phys Letters, 359 (2002) 196-202.

In some examples, the diameter of a multi-walled carbon nanotube is the outer diameter.

In some examples, at least some of the carbon nanotubes added to the release layer have a length of greater than about 0.5 μm, in some examples greater than about 1 μm, in some examples greater than about 1.5 μm before dispersion within a silicone oil.

In some examples, at least some of the carbon nanotubes added to the release layer have a length of less than about 500 μm, in some examples less than about 400 μm, in some examples less than about 300 μm, in some examples less than about 250 μm, in some examples less than about 200 μm, in some examples less than about 100 μm, in some examples less than about 75 μm, in some examples less than about 50 μm, in some examples less than about 25 μm, before dispersion within a silicone oil.

In some examples, at least some of the carbon nanotubes added to the release layer have a length of about 0.5 μm to about 500 μm, in some examples about 1 μm to about 250 μm, before dispersion within a silicone oil.

In some examples, the average length of the carbon nanotubes added to the release layer is greater than about 0.5 μm, in some examples greater than about 1 μm, in some examples greater than about 1.5 μm before dispersion within a silicone oil.

In some examples, the average length of the carbon nanotubes added to the release layer is less than about 500 μm, in some examples less than about 400 μm, in some examples less than about 300 μm, in some examples less than about 250 μm, in some examples less than about 200 μm, in some examples less than about 100 μm, in some examples less than about 75 μm, in some examples less than about 50 μm, in some examples less than about 25 μm, before dispersion within a silicone oil.

In some examples, the average length of the carbon nanotubes added to the release layer is about 0.5 μm to about 500 μm, in some examples about 1 μm to about 250 μm, before dispersion within a silicone oil.

The length of carbon nanotubes may be determined using electron microscopy. The average length may be the number average length or the Gaussian mean length, which may be determined by using electron microscopy to measure the length of a pre-determined sample size of the carbon nanotubes and calculating the number average length of Gaussian mean length from the measured values.

In some examples, the carbon black nanoparticles have a BET surface area of 1000 m²/g or greater, in some examples 1200 m²/g or greater, in some examples 1300 m²/g or greater, in some examples 1400 m²/g or greater.

The BET surface area of the carbon black nanoparticles may be determined according to ASTM Standard D6556-14.

In some examples, at least some of the carbon black nanoparticles have a primary particle diameter of about 42 nm or less, in some examples about 40 nm or less, in some examples about 38 nm or less, in some examples about 36 nm or less, in some examples about 35 nm or less, in some examples about 34 nm or less.

The primary particle diameter of carbon black nanoparticles may be determined using transmission electron microscopy.

In some examples, the mean primary particle diameter of the carbon black nanoparticles is about 42 nm or less, in some examples about 40 nm or less, in some examples about 38 nm or less, in some examples about 36 nm or less, in some examples about 35 nm or less, in some examples about 34 nm or less.

The mean particle diameter of carbon black nanoparticles may be determined according to ASTM standard D3849.

In some examples, the carbon black nanoparticles used have about 20×10¹⁵ primary particles per gram or more, in some examples about 30×10¹⁵ primary particles per gram or more, in some examples about 40×10¹⁵ primary particles per gram or more, in some examples about 50×10¹⁵ primary particles per gram or more, in some examples about 70×10¹⁵ primary particles per gram or more, in some examples about 90×10¹⁵ primary particles per gram or more, in some examples about 100×10¹⁵ primary particles per gram or more, in some examples about 110×10¹⁵ primary particles per gram or more.

In some examples, the carbon black nanoparticles may have a dibutyl phthalate absorption number (DBPA) of at least 200 ml/100 g, in some examples a DBPA number of at least 250 ml/100 g, in some examples a DBPA number of at least 300 ml/100 g, in some examples a DBPA number of at least 350 ml/100 g, in some examples a DBPA number of at least 400 ml/100 g, in some examples a DBPA number of at least 450 ml/100 g, in some examples a DBPA number of at least 475 ml/100 g. Dibutyl phthalate absorption number (DBPA) may be measured, for example, using a standard test, such as ASTM D2414-13a.

In some examples, the outer release layer may comprise greater than about 0.001 wt % carbon nanotubes by weight of silicone polymer, in some examples about 0.01 wt % carbon nanotubes or greater, in some examples about 0.05 wt % carbon nanotubes or greater, in some examples about 0.1 wt % carbon nanotubes or greater, in some examples about 0.5 wt % carbon nanotubes or greater.

In some examples, the outer release layer may comprise less than about 10 wt % carbon nanotubes by weight of silicone polymer, in some examples about 9 wt % carbon nanotubes or less, in some examples about 8 wt % carbon nanotubes or less, in some examples about 7 wt % carbon nanotubes or less, in some examples about 6 wt % carbon nanotubes or less, in some examples about 5 wt % carbon nanotubes or less, in some examples about 4 wt % carbon nanotubes or less, in some examples about 3 wt % carbon nanotubes or less, in some examples about 2 carbon nanotubes wt % or less, in some examples about 1 wt % carbon nanotubes or less.

In some examples, the outer release layer may comprise from about 0.001 wt % carbon nanotubes by weight of silicone polymer to about 10 wt % carbon nanotubes by weight of silicone polymer, in some examples from about 0.01 wt % carbon nanotubes by weight of silicone polymer to about 5 wt % carbon nanotubes by weight of silicone polymer, in some examples from about 0.05 wt % carbon nanotubes by weight of silicone polymer to about 3 wt % carbon nanotubes by weight of silicone polymer, in some examples from about 0.1 wt % carbon nanotubes by weight of silicone polymer to about 2 wt % carbon nanotubes by weight of silicone polymer.

In some examples, the outer release layer may comprise greater than about 0.001 wt % carbon black nanoparticles by weight of silicone polymer, in some examples about 0.01 wt % carbon black nanoparticles or greater, in some examples about 0.05 wt % carbon black nanoparticles or greater, in some examples about 0.1 wt % carbon black nanoparticles or greater, in some examples about 0.5 wt % carbon black nanoparticles or greater.

In some examples, the outer release layer may comprise less than about 10 wt % carbon black nanoparticles by weight of silicone polymer, in some examples about 9 wt % carbon black nanoparticles or less, in some examples about 8 wt % carbon black nanoparticles or less, in some examples about 7 wt % carbon black nanoparticles or less, in some examples about 6 wt % carbon black nanoparticles or less, in some examples about 5 wt % carbon black nanoparticles or less, in some examples about 4 wt % carbon black nanoparticles or less, in some examples about 3 wt % carbon black nanoparticles or less, in some examples about 2 wt % carbon black nanoparticles or less, in some examples about 1 wt % carbon black nanoparticles or less. It has been found that the higher the BET number of the carbon black nanoparticles, the lower amount of carbon black required to achieve desired viscosity and surface/printing effects.

In some examples, the outer release layer may comprise from about 0.001 wt % carbon black nanoparticles by weight of silicone polymer to about 10 wt % carbon black nanoparticles by weight of silicone polymer, in some examples from about 0.01 wt % carbon black nanoparticles by weight of silicone polymer to about 5 wt % carbon black nanoparticles by weight of silicone polymer, in some examples from about 0.05 wt % carbon black nanoparticles by weight of silicone polymer to about 3 wt % carbon black nanoparticles by weight of silicone polymer, in some examples from about 0.1 wt % carbon black nanoparticles by weight of silicone polymer to about 2 wt % carbon black nanoparticles by weight of silicone polymer.

In some examples, the pre-cure release layer composition may comprise greater than about 0.001 wt % carbon nanotubes by weight of silicone oil, in some examples about 0.01 wt % carbon nanotubes or greater, in some examples about 0.05 wt % carbon nanotubes or greater, in some examples about 0.1 wt % carbon nanotubes or greater, in some examples about 0.5 wt % carbon nanotubes or greater.

In some examples, the pre-cure release layer composition may comprise less than about 10 wt % carbon nanotubes by weight of silicone oil, in some examples about 9 wt % carbon nanotubes or less, in some examples about 8 wt % carbon nanotubes or less, in some examples about 7 wt % carbon nanotubes or less, in some examples about 6 wt % carbon nanotubes or less, in some examples about 5 wt % carbon nanotubes or less, in some examples about 4 wt % carbon nanotubes or less, in some examples about 3 wt % carbon nanotubes or less, in some examples about 2 carbon nanotubes wt % or less, in some examples about 1 wt % carbon nanotubes or less.

In some examples, the pre-cure release layer composition may comprise from about 0.001 wt % carbon nanotubes by weight of silicone oil to about 10 wt % carbon nanotubes by weight of silicone oil, in some examples from about 0.01 wt % carbon nanotubes by weight of silicone oil to about 5 wt % carbon nanotubes by weight of silicone oil, in some examples from about 0.05 wt % carbon nanotubes by weight of silicone oil to about 3 wt % carbon nanotubes by weight of silicone oil, from about 0.1 wt % carbon nanotubes by weight of silicone oil to about 2 wt % carbon nanotubes by weight of silicone oil.

In some examples, the pre-cure release layer composition may comprise greater than about 0.001 wt % carbon black nanoparticles by weight of silicone oil, in some examples about 0.01 wt % carbon black nanoparticles or greater, in some examples about 0.05 wt % carbon black nanoparticles or greater, in some examples about 0.1 wt % carbon black nanoparticles or greater, in some examples about 0.5 wt % carbon black nanoparticles or greater.

In some examples, the pre-cure release layer composition may comprise less than about 10 wt % carbon black nanoparticles by weight of silicone oil, in some examples about 9 wt % carbon black nanoparticles or less, in some examples about 8 wt % carbon black nanoparticles or less, in some examples about 7 wt % carbon black nanoparticles or less, in some examples about 6 wt % carbon black nanoparticles or less, in some examples about 5 wt % carbon black nanoparticles or less, in some examples about 4 wt % carbon black nanoparticles or less, in some examples about 3 wt % carbon black nanoparticles or less, in some examples about 2 carbon black nanoparticles wt % or less, in some examples about 1 wt % carbon black nanoparticles or less by weight of silicone oil.

In some examples, the pre-cure release layer composition may comprise from about 0.001 wt % carbon black nanoparticles by weight of silicone oil to about 10 wt % carbon black nanoparticles by weight of oil, in some examples from about 0.01 wt % carbon black nanoparticles by weight of silicone oil to about 5 wt % carbon black nanoparticles by weight of silicone oil, in some examples from about 0.05 wt % carbon black nanoparticles by weight of silicone oil to about 3 wt % carbon black nanoparticles by weight of silicone oil, in some examples from about 0.1 wt % carbon black nanoparticles by weight of silicone oil to about 2 wt % carbon black nanoparticles by weight of silicone oil.

In some examples, the silicone polymer is a polysiloxane that has been cross-linked using an addition cure process such that it contains Si—X—Si bonds, where X is an alkylene moiety, for example —(CH₂)ₙ—, where n may be 2, 3, or 4.

In some examples, the silicone polymer comprises the cross-linked addition cured product of:
at least one silicone oil having alkene groups linked to the silicone chain of the silicone oil;
a cross-linker comprising a silicone hydride component; and, in some examples,
an addition cure cross-linking catalyst.

In some examples, the at least one silicone oil may comprise a polysiloxane having at least two alkene groups per molecule.

In some examples, the silicon hydride component may comprise a polysiloxane having a silicon hydride moiety.

In some examples, the at least one silicone oil has the formula (I):

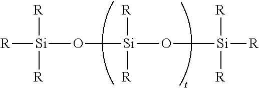

wherein:

each R is independently selected from C₁₋₆ alkyl and C₂₋₆ alkenyl groups, at least two R groups being an alkenyl group; and

t is an integer of at least 1, in some examples at least 10, in some examples at least 100.

In some examples, the alkenyl groups are vinyl groups and the alkyl groups are methyl groups.

In some embodiments the silicone oil has a dynamic viscosity of 100 mPa·s or more, in some examples 200 mPa·s or more, in some examples 300 mPa·s or more, in some examples 400 mPa·s or more.

In some embodiments the silicone oil has a dynamic viscosity of 5000 mPa·s or less, in some examples 1000 mPa·s or less, in some examples 900 mPa·s or less, in some examples 800 mPa·s or less, in some examples 700 mPa·s or less, in some examples 600 mPa·s or less.

In some embodiments the silicone oil has a dynamic viscosity of 100 to 5000 mPa·s, in some examples 100 to 1000 mPa·s, in some examples 200 to 1000 mPa·s, in some examples 200 to 900 mPa·s, in some examples 300 to 800 mPa·s, in some examples 400 to 700 mPa·s, in some examples 400 to 600 mPa·s, in some examples about 500 mPa·s.

In some examples, the silicone oil comprises a dimethylsiloxane homopolymer, in which the alkene groups are vinyl, and are each covalently bonded to end siloxyl units. In some examples, the silicone oil comprises a dimethylsiloxane homopolymer of the α,ω(dimethyl-vinylsiloxy)poly(dimethylsiloxyl) type. In some examples, the dimethylsiloxane homopolymer has a dynamic viscosity of at least 100 mPa·s. In some examples, the dimethylsiloxane homopolymer has a dynamic viscosity of from 100 to 1000 mPa·s, in some examples 200 to 900 mPa·s, in some examples 300 to 800 mPa·s, in some examples 400 to 700 mPa·s, in some examples 400 to 600 mPa·s, in some examples about 500 mPa·s.

In some example, the silicone oil comprises a co-polymer of vinylmethylsiloxane and dimethylsiloxane, and in some examples, a vinyl group is covalently bonded to each of the end siloxyl units of the co-polymer. In some examples the co-polymer of vinylmethylsiloxane and dimethylsiloxane is of the poly(dimethylsiloxyl)((methylvinylsiloxy)α,ω(dimethyl-vinylsiloxy) type.

In some examples, the silicone oil comprises a dimethylsiloxane homopolymer, in which the alkene groups are vinyl, and are each covalently bonded to end siloxyl units, which may be as described above and a co-polymer of vinylmethylsiloxane and dimethylsiloxane, and, in some examples a vinyl group is covalently bonded to each of the end siloxane units of the co-polymer.

In some examples, the co-polymer of vinylmethylsiloxane and dimethylsiloxane has a dynamic viscosity of from 1000 to 5000 mPa·s. In some examples, the co-polymer of vinylmethylsiloxane and dimethylsiloxane has a dynamic viscosity of from 2000 to 4000 mPa·s, in some examples a dynamic viscosity of from 2500 to 3500 mPa·s, in some examples a dynamic viscosity of about 3000 mPa·s.

The silicon hydride component may comprise a polysiloxane having a silicon hydride (Si—H) moiety. The silicon hydride moiety may be at an end siloxyl unit or an intermediate siloxyl unit in the polysiloxane of the silicon hydride component. In some examples, the silicon hydride component is selected from a polysiloxane of the poly(dimethylsiloxy)-(siloxymethylhydro)-α,ω-(dimethylhydrosiloxy) type and α,ω-(dimethylhydrosiloxy) poly-dimethylsiloxane. In some examples, the polysiloxane having a silicon hydride (Si—H) moiety has a dynamic viscosity of at least 100 mPa·s, in some examples at least 500 mPa·s. In some examples, the polysiloxane having a silicon hydride (Si—H) moiety has a dynamic viscosity of from 100 mPa·s to 2000 mPa·s, in some examples a dynamic viscosity of from 300 mPa·s to 1500 mPa·s, in some examples a dynamic viscosity of from 500 mPa·s to 1300 mPa·s, in some examples a dynamic viscosity of from 700 mPa·s to 1100 mPa·s, in some examples a dynamic viscosity of from 800 mPa·s to 1000 mPa·s, in some examples a dynamic viscosity of around 900 mPa·s.

In some examples, the silicone polymer may have been cross-linked using an addition cure process involving the addition cure of at least one silicone oil having alkene groups linked to the silicone chain of the silicone oil and a cross-linker comprising a silicon hydride component and an addition cure cross-linking catalyst, for example a catalyst comprising platinum.

In some examples, the silicone polymer comprises the cross-linked condensation cured product of:
at least one silicone oil;
a condensation cure cross-linker component; and
a condensation cure cross-linking catalyst.

In some examples the condensation cure cross-linker component is an acetoxy silane component, an alkoxy silane component, an oxime component, an enoxy silane component, an amino silane component, or a benzamido silane component. The at least one silicone oil may be a siloxane, in some examples a hydroxyl-functional siloxane, in some examples a hydroxyl-terminated siloxane, in some examples a siloxane having at least one hydroxyl group per molecule, in some examples at least two hydroxyl groups per molecule.

In some examples, the silicone polymer comprises the UV or IR radiation cross-linked cured product of:
at least one silicone oil;
a photo cross-linker; and
a photo-initiator.

In some examples, the silicone polymer comprises the activated cross-linked cured product of:
at least one silicone oil;
a cross-linker comprising a peroxide component; and
an activated cure cross-linking catalyst.

In some examples, the silicone oil comprises a polydimethlysiloxane.

In some examples, the pre-cure release layer composition may comprise a silicone oil in which an additive selected from carbon nanotubes and carbon black nanoparticles, the carbon black nanoparticles having a BET surface area of 700 m²/g or greater, has been dispersed. In some examples, the additive may be dispersed in the silicone oil by applying high mechanical shear rates.

In some examples, a carbon nanotube additive is dispersed in the silicone oil by applying a shear rate of about 5000 rpm or greater, in some examples about 6000 rpm or greater, in some examples about 8000 rpm or greater, in some examples about 9000 rpm or greater, in some examples about 10000 rpm or greater. In some examples the shear rate is applied for at least 3 minutes, in some examples at least 5 minutes, in some examples at least 6 minutes.

In some examples, a carbon black nanoparticle additive is dispersed in the silicone oil by applying a shear rate of about 4000 rpm or greater, in some examples about 5000 rpm or greater, in some examples about 6000 rpm or greater. In some examples the shear rate is applied for at least 3 minutes, in some examples at least 5 minutes, in some examples at least 6 minutes.

In some examples the silicone oil containing an additive selected from carbon nanotubes and carbon black nanoparticles, the carbon black nanoparticles having a BET surface area of 700 m²/g or greater, dispersed therein has a dynamic viscosity of 500 mPa·s or more, in some examples 1000 mPa·s or more, in some examples 2000 mPa·s or more, in some examples 3000 mPa·s or more, in some examples 4000 mPa·s or more, in some examples 5000 mPa·s or more, in some examples 6000 mPa·s or more.

In some examples the silicone oil containing an additive selected from carbon nanotubes and carbon black nanoparticles, the carbon black nanoparticles having a BET surface area of 700 m²/g or greater, dispersed therein has a dynamic viscosity of 400 000 mPa·s or less, in some examples 200 000 mPa·s or less, in some examples 100 000 mPa·s or less, in some examples 10 000 mPa·s or less.

In some examples the silicone oil containing an additive selected from carbon nanotubes and carbon black nanoparticles, the carbon black nanoparticles having a BET surface area of 700 m²/g or greater, dispersed therein has a dynamic viscosity of 200 to 400 000 mPa·s, in some examples 500 to 100 000 mPa·s, in some examples 1000 to 10 000 mPa·s.

In some examples, viscosities described herein may be determined according to ASTM D4283-98(2010) Standard Test Method for Viscosity of Silicone Fluids. In some examples, viscosities described herein may be measured on a viscometer, such as a Brookfield DV-II+Programmable viscometer, using appropriate spindles, including, but not limited to, a spindle selected from spindle LV-4 (SP 64) 200-1,000 [mPa·s] for Newtonian fluids (pure silicones) and spindle LV-3 (SP 63) 200-400000 [mPa·s] for non-Newtonian fluids (silicone oils with carbon nanotube or carbon nanoparticle additives).

### Intermediate Transfer Member (ITM)

The ITM may have a base, for example a metal base. The base may have a cylindrical shape. The base may form part of the supportive portion of the ITM.

The ITM may have a cylindrical shape, as such the ITM may be suitable for use as a roller, for example a roller in a printing apparatus.

The supportive portion of the ITM may comprise a layered structure disposed on the base of the ITM. The layered structure may comprise a compliant substrate layer, for example a rubber layer, on which the outer release layer may be disposed.

The compliant substrate layer may comprise a rubber layer comprising an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The ITM may comprise a primer layer to facilitate bonding or joining of the release layer to the compliant layer. The primer layer may form part of the supportive portion of the ITM, in some examples the primer layer is disposed on the compliant substrate layer.

In some examples, the primer layer may comprise an organosilane, for example, an organosilane derived from an epoxysilane such as 3-glycidoxypropyl trimethylsilane, a vinyl silane such as vinyltriethoxysilane, a vinyltriethoxysilane, an allyl silane, or an unsaturated silane, and a catalyst such as a catalyst comprising titanium or platinum.

The primer layer may be formed from a curable primer layer. The curable primer layer may be applied to the compliant substrate layer of the supportive portion of the ITM before the outer release layer is formed on the supportive portion. The curable primer layer may comprise an organosilane and a catalyst, for example a catalyst comprising titanium.

In some examples the organosilane contained in the curable primer layer is selected from an epoxysilane, a vinyl silane, an allyl silane and an unsaturated silane.

The curable primer layer may comprise a first primer and a first catalyst, and a second primer and a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example a catalyst comprises titanium. The first primer may be cured by a condensation reaction by the first catalyst. In some examples, the second primer may be cured by a condensation reaction by the first catalyst.

In some examples, the second catalyst is a catalyst for catalysing an addition cure reaction. In such cases, the second catalyst may catalyse an addition cure reaction of the pre-cure release composition to form the release layer.

The curable primer layer may be applied to the compliant layer as a composition containing the first and second primer and first and second catalyst.

In some examples the curable primer layer may be applied to the compliant layer as two separate compositions, one containing the first primer and first catalyst, the other containing the second primer and second catalyst.

In some examples, the ITM may comprise an adhesive layer for joining the compliant substrate layer to the base. The adhesive layer may be a fabric layer, for example a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer, a compliance layer and/or a conductive layer.

In some examples the compressible layer is disposed on the base of the ITM. The compressible layer may be joined to the base of the ITM by the adhesive layer. A conductive layer may be disposed on the compressible layer. The compliance layer may then be disposed on the conductive layer if present, or disposed on the compressible layer if no conductive layer is present.

The compressible layer may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS).

The compliance layer may comprise a soft elastomeric material having a Shore A hardness of less than about 65, or a Shore A hardness of less than about 55 and greater than about 35, or a Shore A hardness value of between about 42 and about 45. In some examples, the compliance layer 27 comprises a polyurethane or acrylic. Shore A hardness may be determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM) In an example the compressible layer and the compliance layer are formed from the same material.

The conductive layer may comprise a rubber, for example an acrylic rubber (ACM), a nitrile rubber (NBR), a hydrogenated nitrile rubber (HNBR), or an EPDM rubber (an ethylene propylene diene terpolymer), and one or more conductive materials.

In some examples, the compressible layer and/or the compliance layer may be made to be partially conducting with the addition of conducting particles, for example conductive carbon black or metal fibres. In some examples where the compressible layer and/or the compliance layer are partially conducting there may be no requirement for an additional conductive layer.

### Electrostatic Liquid Electro Photographic (LEP) Printing Apparatus

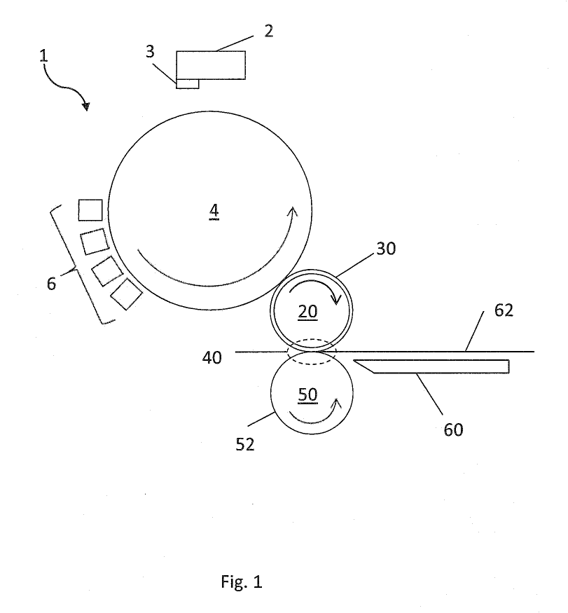

FIG. 1 shows a schematic illustration of an example of an LEP 1. An image, including any combination of graphics, text and images, is communicated to the LEP 1. The LEP includes a photo charging unit 2 and a photo-imaging cylinder 4. The image is initially formed on a photo-conductive member in the form of a photo-imaging cylinder 4 before being transferred to an outer release layer 30 of the ITM 20 which is in the form of a roller (first transfer), and then from the outer release layer 30 of the ITM 20 to a print substrate 62 (second transfer).

According to an illustrative example, the initial image is formed on a rotating photo-imaging cylinder 4 by the photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Ink is then transferred to the photo-imaging cylinder 4 by Binary Ink Developer (BID) units 6. The BID units 6 present a uniform film of ink to the photo-imaging cylinder 4. The ink contains electrically charged pigment particles which, by virtue of an appropriate potential on the electrostatic image areas, are attracted to the latent electrostatic image on the photo-imaging cylinder 4. The ink does not adhere the uncharged, non-image areas and forms a developed toner image on the surface of the latent electrostatic image. The photo-imaging cylinder 4 then has a single colour ink image on its surface.

The developed toner image is then transferred from the photo-imaging cylinder 4 to the outer release layer 30 of the ITM 20 by electrical forces. The image is then dried and fused on the outer release layer 30 of the ITM 20 before being transferred from the outer release layer 30 of the ITM 20 to a print substrate wrapped around an impression cylinder 50. The process may then be repeated for each of the coloured ink layers to be included in the final image.

The image is transferred from the photo-imaging cylinder 4 to the ITM 20 by virtue of an appropriate potential applied between the photo-imaging cylinder 4 and the ITM 20, such that the charged ink is attracted to the ITM 20.

Between the first and second transfers the solid content of the developed toner image is increased and the ink is fused on to the ITM 20. For example, the solid content of the developed toner image deposited on the outer release layer 30 after the first transfer is typically around 20%, by the second transfer the solid content of the developed toner image is typically be around 80-90%. This drying and fusing is typically achieved by using elevated temperatures and air flow assisted drying. In some examples, the ITM 20 is heatable.

The print substrate 62 is fed into the printing apparatus by the print substrate feed tray 60 and is wrapped around the impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 is retained on the impression cylinder 50 and makes multiple contacts with the ITM 20 as it passes through the nip 40. At each contact an additional colour plane may be placed on the print substrate 62.

### Intermediate Transfer Member

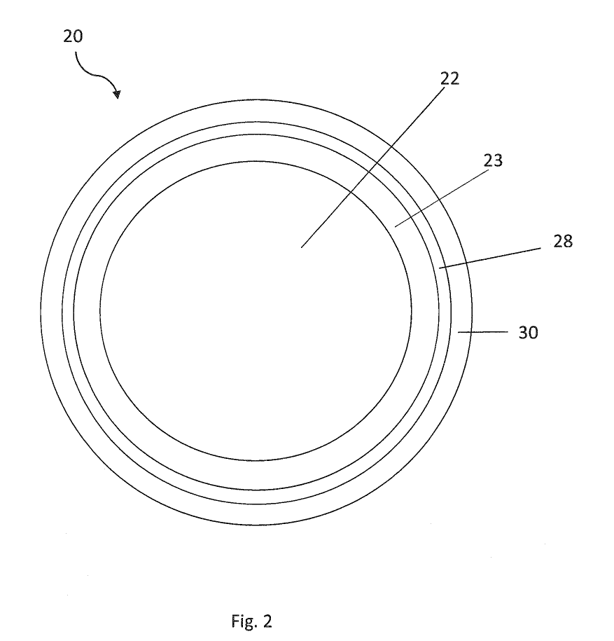

FIG. 2 is a cross-sectional diagram of an example of an ITM. The ITM includes a supportive portion comprising a base 22 and a substrate layer 23 disposed on the base 22. The base 22 may be a metal cylinder. The ITM 20 also comprises a primer layer 28 disposed on the substrate layer 23, and an outer release layer 30 disposed on the primer layer 28.

The substrate layer 23 comprises a rubber layer which may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM). For example, the rubber layer may comprise an at least partly cured acrylic rubber, for example an acrylic rubber comprising a blend of acrylic resin Hi-Temp 4051 EP (Zeon Europe GmbH, Niederkasseler Lohweg 177, 40547 Düsseldorf, Germany) filled with carbon black pearls 130 (Cabot, Two Seaport Lane, Suite 1300, Boston, Mass. 02210, USA) and a curing system which may comprise, for example, NPC-50 accelerator (ammonium derivative from Zeon).

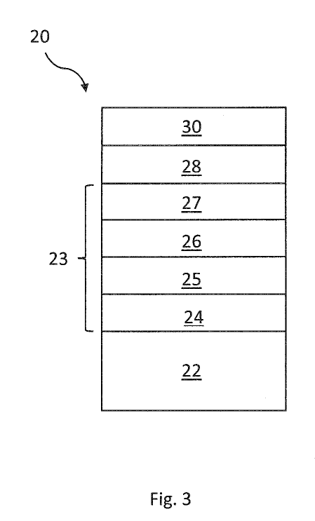

FIG. 3 shows a cross-sectional view of an example of an ITM having a substrate layer 23 comprising an adhesive layer 24 disposed between the base 22 and a compressible layer 25 for joining the compressible layer 25 of the substrate layer 23 to the base 22, a conductive layer 26 may be disposed on the compressible layer 25, and a compliance layer 27 disposed on the conductive layer 26. The adhesive layer may be a fabric layer, for example a woven or non-woven cotton, synthetic, combined natural and synthetic, or treated, for example, treated to have improved heat resistance, material. In an example the adhesive layer 23 is a fabric layer formed of NOMEX material having a thickness, for example, of about 200 μm.

The compressible layer 25 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS).

The compliance layer 27 may comprise a soft elastomeric material having a Shore A hardness of less than about 65, or a Shore A hardness of less than about 55 and greater than about 35, or a Shore A hardness value of between about 42 and about 45. In some examples, the compliance layer 27 comprises a polyurethane or acrylic. Shore A hardness may be determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM)

In an example the compressible layer 25 and the compliance layer 27 are formed from the same material.

The conductive layer 26 comprises a rubber, for example an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer 26 may be omitted, such as in some examples in which the compressible layer 25, the compliance layer 27, or the release layer 30 are partially conducting. For example, the compressible layer 25 and/or the compliance layer 27 may be made to be partially conducting with the addition of conductive carbon black or metal fibres.

The primer layer 28 may be provided to facilitate bonding or joining of the release layer 30 to the substrate layer 23. The primer layer 28 may comprise an organosilane, for example, an organosilane derived from an epoxysilane such as 3-glycidoxypropyl trimethylsilane, a vinyl silane such as vinyltriethoxysilane, a vinyltriethoxysilane, an allyl silane, or an unsaturated silane, and a catalyst such as a catalyst comprising titanium.

In an example, a curable primer layer is applied to a compliance layer 27 of a substrate layer 23, for example to the outer surface of a compliance layer 27 made from an acrylic rubber. The curable primer layer may be applied using a rod coating process. The curable primer may comprise a first primer comprising an organosilane and a first catalyst comprising titanium, for example an organic titanate or a titanium chelate. In an example the organosilane is an epoxysilane, for example 3-glycidoxypropyl trimethoxysilane (available from ABCR GmbH & Co. KG, Im Schlehert 10 D-76187, Karlsruhe, Germany, product code SIG5840) and vinyltriethoxysilane (VTEO, available from Evonik, Kirschenallee, Darmstadt, 64293, Germany), vinyltriethoxysilane, an allyl silane or an unsaturated silane. The first primer is curable by, for example, a condensation reaction. For example, the first catalyst for a silane condensation reaction may be an organic titanate such as Tyzor® AA75 (available from Dorf-Ketal Chemicals India Private Limited Dorf Ketal Tower, D'Monte Street, Orlem, Malad (W), Mumbai-400064, Maharashtra INDIA.). The primer may also comprise a second primer comprising an organosilane, e.g. a vinyl siloxane, such as a vinyl silane, for example vinyl triethoxy silane, vinyltriethoxysilane, an allyl silane or an unsaturated silane, and, in some examples, a second catalyst. The second primer may also be curable by a condensation reaction. In some examples, the second catalyst, if present, may be different from the first catalyst and in some examples comprises platinum or rhodium. For example, the second catalyst may be a Karstedt catalyst with, for example, 9% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, Pa. 19067, USA).

In some examples, the second catalyst is a catalyst for catalysing an addition cure reaction. In such cases the second catalyst may catalyse an addition cure reaction of the pre-cure release composition to form the release layer 30 when the pre-cure release composition comprises at least one silicone oil having alkene groups linked to the silicone chain of the silicone oil, for example a vinyl functional siloxane and a cross-linker comprising a silicone hydride component.

The curable primer layer applied to the substrate layer 23 may comprise a first primer and/or a second primer. The curable primer layer may be applied to the substrate layer 23 as two separate layers, one layer containing the first primer and the other layer containing the second primer.

The rubbers of the compressible layer 25, the conductive layer 26 and/or the compliance layer 27 of the substrate layer 23 may be uncured when the curable primer layer is applied thereon.

The outer release layer 30 of the ITM 20 comprises a silicone polymer matrix and an additive dispersed in the silicone polymer matrix, the additive selected from carbon nanotubes and carbon black nanoparticles having a BET surface area of 700 m²/g.

The outer release layer 30 may be formed on the ITM by applying a pre-cure release layer composition to the supportive portion of the ITM. For example, the outer release layer may be applied to the substrate layer 23 or on top of a curable primer layer which has already been applied to the substrate layer 23.

The pre-cure release layer composition may comprise at least one silicone oil having alkene groups linked to the silicone chain of the silicone oil; a cross-linker comprising a silicon hydride component and an additive selected from carbon nanotubes and carbon black nanoparticles, the carbon black nanoparticles having a BET surface area of 700 m²/g or greater. In some examples, the pre-cure release composition may contain a catalyst, for example a platinum containing catalyst or a rhodium containing catalyst.

In some examples, the at least one silicone oil may comprise a polysiloxane having at least two alkene groups per molecule. For example, the silicone oil may comprise a dimethylsiloxane homopolymer, in which the alkene groups are vinyl, and are each covalently bonded to end siloxyl units. In some examples, the silicone oil comprises a dimethylsiloxane homopolymer of the α,ω(dimethyl-vinylsiloxy)poly(dimethylsiloxyl) type.

In some example, the silicone oil comprises a co-polymer of vinylmethylsiloxane and dimethylsiloxane, and in some examples, a vinyl group is covalently bonded to each of the end siloxyl units of the co-polymer. In some examples the co-polymer of vinylmethylsiloxane and dimethylsiloxane is of the poly(dimethylsiloxyl)((methylvinylsiloxy)α,ω(dimethyl-vinylsiloxy) type.

In some examples, the silicone oil comprises a dimethylsiloxane homopolymer, in which the alkene groups are vinyl, and are each covalently bonded to end siloxyl units, which may be as described above and a co-polymer of vinylmethylsiloxane and dimethylsiloxane, and, in some examples a vinyl group is covalently bonded to each of the end siloxane units of the co-polymer.

The silicon hydride component may comprise a polysiloxane having a silicon hydride (Si—H) moiety. The silicon hydride moiety may be at an end siloxyl unit or an intermediate siloxyl unit in the polysiloxane of the silicon hydride component. In some examples, the silicon hydride component is selected from a polysiloxane of the poly(dimethylsiloxy)-((siloxymethylhydro)-α,ω-(dimethylhydrosiloxy) type and α,ω-(dimethylhydrosiloxy) poly-dimethylsiloxane.

In some examples the pre-cure release layer composition may comprise at least one silicone oil; a cross-linker comprising a condensation cure cross-linker component and an additive selected from carbon nanotubes and carbon black nanoparticles, the carbon black nanoparticles having a BET surface area of 700 m²/g or greater. In some examples, the pre-cure release composition may contain a catalyst, for example a titanium containing catalyst.

In some examples the pre-cure release layer composition may comprise at least one silicone oil; a cross-linker comprising a peroxide component and an additive selected from carbon nanotubes and carbon black nanoparticles, the carbon black nanoparticles having a BET surface area of 700 m²/g or greater. In some examples, the pre-cure release composition may contain an activated cure cross-linking catalyst.

In some examples the pre-cure release layer composition may comprise at least one silicone oil; a photo cross-linker component and an additive selected from carbon nanotubes and carbon black nanoparticles, the carbon black nanoparticles having a BET surface area of 700 m²/g or greater. In some examples, the pre-cure release composition may contain a photo-initiator.

In some examples, the silicone oil comprises a polydimethlysiloxane.

Once cured, the ITM comprises an outer release layer 30 disposed on a substrate layer 23, or, if present, disposed on a primer layer 28.

In some examples, the silicone polymer matrix of the outer release layer 30 comprises the cross-linked product of the at least one silicone oil and the silicon hydride cross-linking component.

### EXAMPLES

The following examples illustrate a number of variations of the present printing apparatus, intermediate transfer member and related aspects that are presently known to the inventors. However, it is to be understood that the following are only examples or illustrative of the application of the principles of the present printing apparatus, intermediate transfer member and related aspects. Numerous modifications and alternative methods may be devised by those skilled in the art without departing from the spirit and scope of the printing apparatus, intermediate transfer member and related aspects. The appended claims are intended to cover such modifications and arrangements. Thus, while the present apparatus and related aspects have been described above with particularity, the following examples provide further detail in connection with what are presently deemed to be acceptable.

### ITM (Blanket) Structure and Release Application

The blanket structure from bottom to top (top is a release layer; bottom is a layer which is in contact with metal ITM drum):
1. Fabric based (woven or non-woven cotton, synthetic, combined, treated (according to heat resistance needed in some case) support layer.
2. Rubber based (NBR, HNBR, ACM, EPDM, PU, FLS or other) compressible layer with large range of compressibility (in this example NBR from ContiTech AG Vahrenwalder Str. 9 30165 Hannover Germany)
3. Rubber based (NBR, HNBR, ACM, EPDM) conductive layer (in this example NBR from ContiTech)
4. Rubber based (NBR, HNBR, ACM, EPDM, PU, FMQ, FPM, FKM, FFKM) soft compliance layer (in this example ACM from ContiTech)
5. Primer layer may comprise a one or more portion (coated on substrate (rubber layer no 4) as a layer by layer. Primer formulation is described in table 1.
6. Release layer described in table 2

### Comparative Example 1

Using a rod coating process, a primer having the composition shown in Table 1 was coated onto the uncured acrylic rubber (ACM) of the compliance layer of the ITM described above. In this example the uncured primer contains a first primer and a second primer mixed together.

TABLE 1

| | parts by weight in | |
|---|---|---|
| Materials of primer | formulation | Supplier |
| 3Glycidoxypropyl) | 54 | ABCR |
| trimethoxysilane | | |
| Vinyltrimethoxysilane | 35 | ABCR |
| Tyzor AA75 | 10 | Dorf Ketal |
| Karstedt solution 9% Pt | 1 | Johnson Matthey |

A pre-cure release layer composition having the composition shown in Table 2 was then provided on the primer using a rod coating process. After the coating process was complete, the whole ITM was placed in oven at 120° C. for 1.5 h.

TABLE 2

| | parts by weight in | |
|---|---|---|
| Materials of release | formulation | Supplier |
| Dimethylsiloxane | 50 | ABCR |
| vinyl terminated | | |
| vs500 | | |
| Vinylmethylsiloxane - | 50 | ABCR |
| Dimethylsiloxane | | |
| Copolymer vinyl | | |
| terminated xprv5000 | | |
| Hydride siloxane | 14 | ABCR |
| Karstedt solution | 0.5 | ABCR |
| 0.5% Pt | | |

### Example 1

An ITM was formed in the same way as in comparative example 1 except that a MWCNT additive was incorporated into the dimethylsiloxane vinyl terminated vs500 before formation of the pre-cure release composition. The MWCNT used were IG-CNT, industrial grade multiwall carbon nanotubes having a purity of greater than 85 wt %, a diameter of 15 nm, and a nominal length of greater than 20 microns (obtained from NanoLab, Inc. 179 Bear Hill Road Waltham, Mass. 02451 USA). In other examples the MWCNTs used could be NC7000, Industrial grade multiwall carbon nanotubes having a purity of greater than 90 wt %, a diameter of 9.5 nm, and a nominal length of greater than 2 microns (obtained from NanoCYL, Rue de l'Essor, 4 B-5060 Sambreville, BELGIUM).

In this example vs 500 (vinyl terminated PDMS) with previously added 0.5 wt % of MWCNT by weight of vs 500 was mixed for 6 minutes in stator rotor at 10000 rpm. Then the dispersion was passed through a M-110P Microfluidizer Processor with a 200/75 μm stainless steel/ceramic channels and an input pressure up to 30 kpsi. The dispersion was collected at the product outlet, and then passed through the microfluidic homogenizer repeatedly for a total of six passes, which increase the dispersion viscosity which indicate better and homogeneous dispersion (see Table 3).

### Example 2

An ITM was formed in the same way as in comparative example 1 except that an additive containing carbon black nanoparticles was incorporated into the dimethylsiloxane vinyl terminated vs500 before formation of the pre-cure release composition. The carbon black nanoparticle additive used was (Ketjenblack 600JD from AkzoNobel).

In this example 1 wt % of Carbon black (Ketjenblack 600JD from AkzoNobel) by weight of vs 500 was dispersed in vs 500 (vinyl terminated PDMS) using Ross Model HSM-100LCI-T Laboratory High Shear Mixer (obtained from Charles Ross & Son Company 710 Old Willets Path P.O. Box 12308 Hauppauge, N.Y. 11788-4193) for 6 minutes at 6000 rpm. Homogeneous dispersion with increased viscosity and improved conductivity was obtained (see Table 3)

Table 3 below shows that incorporation of carbon nanotubes or carbon black nanoparticles into vs 500 (vinyl terminated PDMS) increased the viscosity and improved the conductivity of vs 500 containing these additives compared to pure vs 500. The increase in viscosity shown for vs 500 comprising a carbon nanotube or carbon black nanoparticle additive indicates homogeneous dispersion of the additives within the vs 500.

TABLE 3

| | Viscosity (mPa*s) | Resistivity (kΩ) |
|---|---|---|
| 0.5% MWCNT in vs500 | 6000 | 600 |
| 1% CB (Ketjenblack 600JD) in | 4400 | 700 |
| vs500 | | |
| Pure vs500 | 500 | — |

The viscosities were determined using BROOKFIELD DV-II+PROGRAMMABLE VISCOMETER, and spindle LV-4 (SP 64) for 200 to 1000 mPa·s for Newtonian fluids (silicone oils without carbon nanotube or carbon nanoparticle additives) and spindle LV-3 (SP 63) for 200 to 400000 mPa·s for non-Newtonian fluids (silicone oils with carbon nanotube or carbon nanoparticle additives). All viscosities were determined at 25° C.

The resistivity of the samples was measured using a Fluke 187 GEO Earth Ground Testers (DC, Applied voltage 0.3V).

Samples of pure vs 500, vs 500 containing 0.5 wt % MWCNT (IG-CNT from NanoLab and vs 500 containing 1.0 wt % of carbon black nanoparticles (Ketjenblack 600JD from AkzoNobel) were prepared and cured at 120° C. for 1.5 hours in an oven. The samples were then tested to compare the swelling capacity, tensile strength, elongation and surface roughness. The MWCNT and carbon black nanoparticle additives were dispersed in the vs 500 as described in Examples 1 and 2 above.

In order to determine the amount of swelling shown by the different samples, specific sized samples were prepared, each having a width and length of 3 cm and a thickness of 2 mm. The initial weight of each 3 cm×3 cm×2 mm sample was recorded (dry weight) before the samples were immersed in isopar oil for 12 hours at 100° C. The samples were then removed from the isopar oil, and the weight (wet weight) of each sample recorded. The swelling capacity was determined according to the following equation: ((wet weight−dry weight)/dry weight)×100%.

The tensile strength and elongation of each sample was measured using Instron 5500R (Instron Worldwide Headquarters, 825 University Ave., Norwood, Mass. 02062-2643) using a 5 kN load cell, selecting the testing method “tensile test”, and using a run speed run of 200 mm/sec. The samples tested had the dimensions of width 11.95 cm, length 60 cm and thickness 60 cm.

The surface roughness of each of the release layers of the ITMs prepared in Comparative Example 1 and Examples 1 and 2 were measured using an optical interferometer, Zygo Microscopy (model Zygo 200, CCD detector) having a sample range of 0.3 mm×0.3 mm. Each sample was soaked in isopar oil for 1 minute by dropping one drop of isopar oil on the sample from a plastic pipette and the isopar residuals were removed using a cloth prior to measuring the surface roughness.

Table 4 below shows the swelling capacity, tensile strength, elongation and surface roughness shown by each of the samples.

TABLE 4

| | pure | vs 500 | Vs 500 |
|---|---|---|---|
| | vs 500 | silicone matrix | silicone matrix |
| | silicone matrix | with 0.5 wt % | with 1 wt % |
| Physical parameter | (reference) | MWCNT | CB |
| Swelling (%) | 105 (±3) | 113(±3) | 114(±3) |
| Tensile strength (Mpa) | 0.86 (±0.18) | 1.04(±0.18) | 1.01(±18) |
| Elongation (%) | 95(±10) | 96(±10) | 100(±10) |
| Surface roughness | 0.3 (±0.013) | 0.7 (±0.12) | 0.9 (±0.15) |
| (μm) | | | |

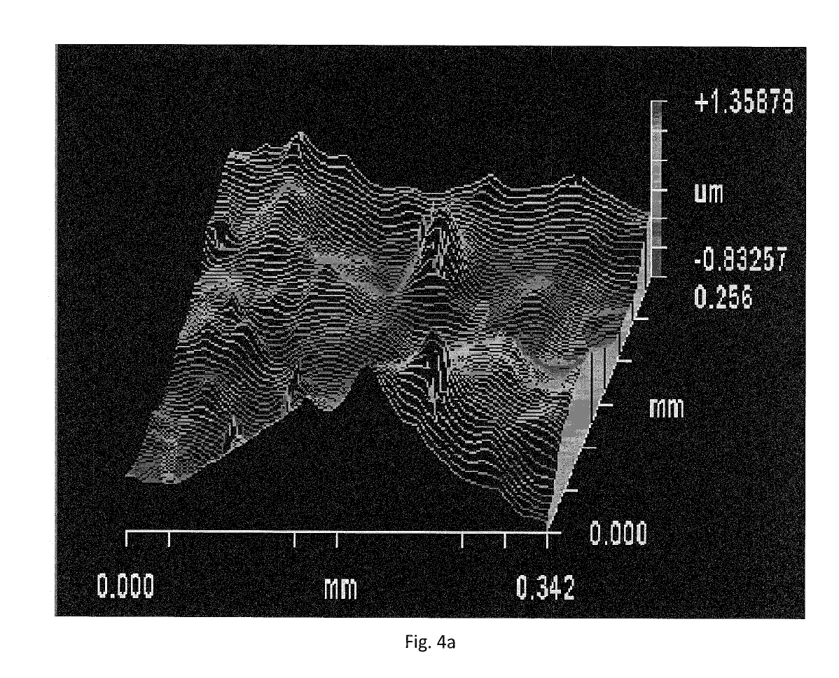

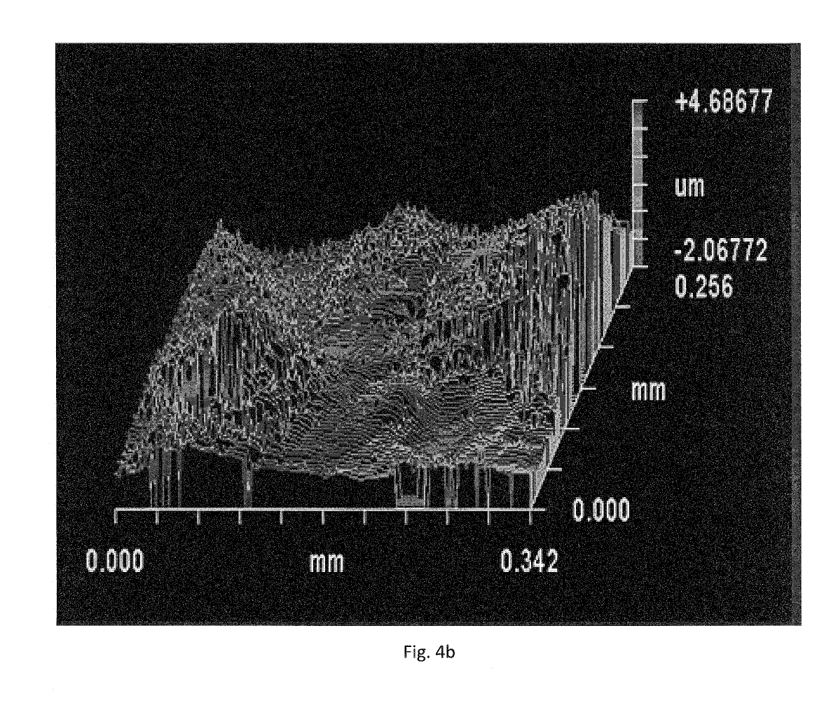

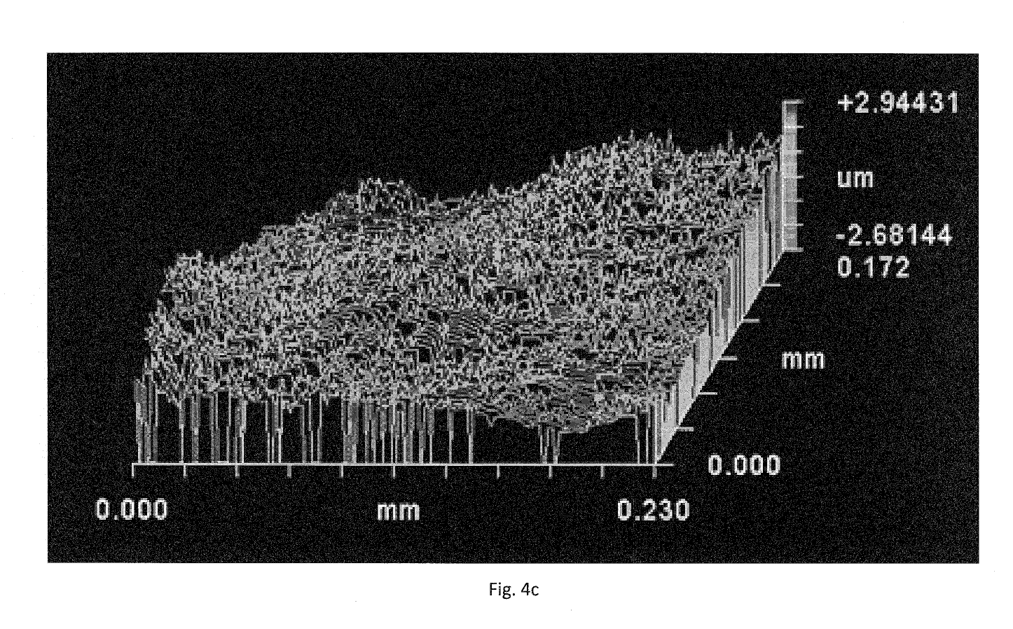

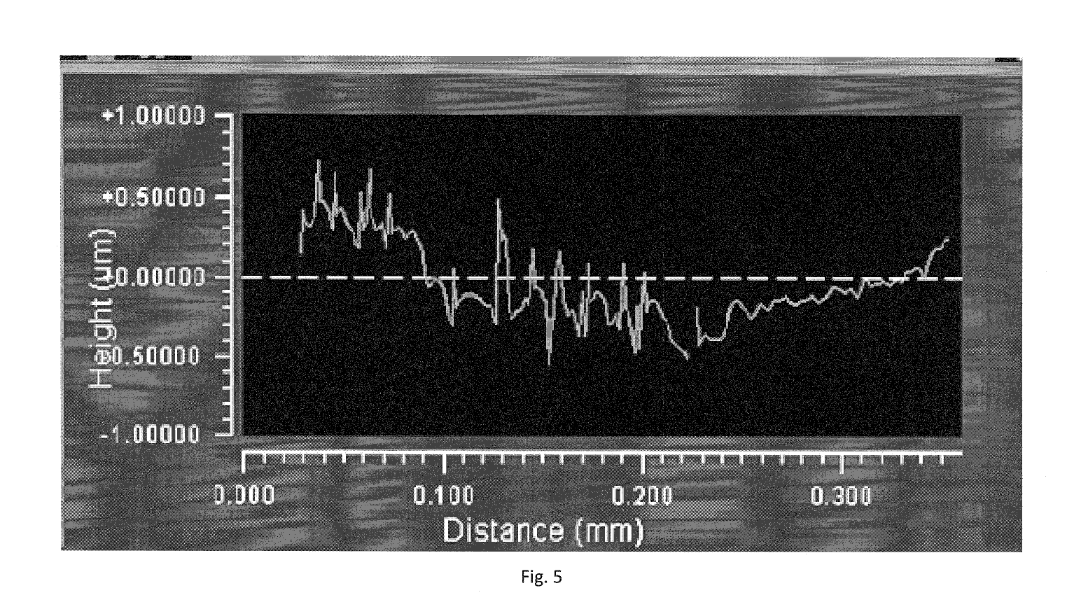

FIGS. 4a, 4b and 4c show Zygo images of the surface of the outer release layers of the ITM prepared according to Comparative Example 1, Example 1, and Example 2 respectively and soaked in isopar for 1 minute to swell the release layers. These figures show that addition of carbon nanotubes or carbon black nanoparticles to the silicone release layer creates a nanometric roughness on the surface of the release layer on swelling in isopar. This nanometric surface roughness of the release layer of the ITM of Example 1 swelled in isopar oil is also illustrated in the line graph of FIG. 5.

The present inventors have found that the nanometric surface roughness of the release layer created by the addition of carbon nanotubes or carbon black nanoparticles to the release layer reduces the surface energy of the outer release layer which allows for better transfer of a developed toner image from the ITM to the print substrate and also better drying of the developed toner image on the outer release layer of the ITM before transfer to the print substrate. This reduction in surface energy and improved drying of ink on the outer release layer is thought to be related to the Fakir effect caused by the nanometric surface roughness.

It has been found that printing using a printing apparatus with an existing ITM can result in a short term memory being created in the outer release layer of the ITM. If a short term memory is created in the outer release layer of the ITM, this results in a visual pattern of a previous image in a developed toner image formed on a print substrate.

The effect of incorporation of carbon nanotube or carbon black nanoparticle additives into an outer release layer of an ITM on the short term memory of the outer release layer of the ITM was tested by incorporating the ITMs produced according to Comparative Example 1, Example 1 and Example 2 into a printing apparatus, in this example the 7600 Indigo press. Each printing apparatus was used to print solid squares of 400% coverage for five impressions on five print substrates followed immediately by a grey monitor print as the sixth impression on the sixth print substrate.

The grey monitor print produced using the printing apparatus comprising the ITM produced according to Comparative Example 1 showed clear ghost squares on the grey image, the ghost squares being darker than the remaining grey image, indicating short term memory of the outer release layer of the ITM having an outer release layer containing no carbon nanotube or carbon black nanoparticle additives.

The grey monitor print produced using the printing apparatus comprising the ITM produced according to Example 1 showed a grey image with barely visible darker ghost squares. Therefore, the outer release layer containing 0.5 wt % carbon nanotube additive showed a greatly improved short term memory.

The grey monitor print produced using the printing apparatus comprising the ITM produced according to Example 2 showed ghost squares on the grey image, although these ghost squares were much less obvious than the ghost squares on the printed substrate produced using the printing apparatus containing the ITM according to Comparative Example 1. Therefore, the inclusion of 1 wt % carbon black nanoparticle additive in the outer release layer improves the short term memory of the outer release layer.

It has been found that existing release layers can suffer from negative dot gain memory which is a failure on grey levels when the ex-image area is brighter than the ex-background area, that is, dot gain in the ex-image area is smaller than in the ex-background area. A negative dot gain memory of the release layer will appear as brighter ghost images of the ex-images area compared to a subsequently printed grey monitor image.

The negative dot gain memory of the release layers of the ITMs obtained according to Comparative Example 1 and Example 2 were tested using printing apparatuses comprising these ITMs. For each of the ITMs a constant image was printed for 2000 impressions followed immediately by a grey monitor image.

The grey monitor image printed by the printing apparatus comprising an ITM produced according to Comparative Example 1 showed distinct brighter ghost images which illustrates the negative dot gain memory of the release layer of the ITM of Comparative Example 1.

Although the grey monitor image printed by the printing apparatus comprising an ITM produced according to Example 2 showed brighter ghost images, these ghost images were much less pronounced than those produced by the release layer of the ITM of Comparative Example 1. Therefore, addition of the carbon black nanoparticles to the release layer of the ITM of Example 2 results in a much improved negative dot gain memory.

The short term memory and negative dot gain memory shown by existing release layers, for example the release layer of the ITM of Comparative Example 1, have been improved by increasing ITM voltage. However, printing using a high ITM bias voltage has been found to cause low printing quality. Therefore, using carbon nanotube or carbon black nanoparticle additives improves short term memory and negative dot gain memory without the negative side effects of counteracting these problems by using an increased ITM voltage.

While the printing apparatus, intermediate transfer member and related aspects have been described with reference to certain examples, those skilled in the art will appreciate that various modifications, changes, omissions, and substitutions can be made without departing from the spirit of the disclosure. It is intended, therefore, that the present printing apparatus, intermediate transfer member and related aspects be limited only by the scope of the following claims. Unless otherwise stated, the features of any dependent claim can be combined with the features of any of the other dependent claims, and any other independent claim.

1. An electrostatic printing apparatus comprising:
a photoconductive member having a surface on which can be created a latent electrostatic image;
an intermediate transfer member comprising:
a supportive portion; and
an outer release layer disposed on the supportive portion comprising a base polymer matrix and an additive selected from carbon nanotubes and carbon black nanoparticles, the carbon black nanoparticles having a BET surface area of 700 m²/g or greater, the additive being dispersed in the base polymer matrix, and the base polymer being a silicone polymer; wherein the electrostatic printing apparatus is adapted, in use, on contacting the surface of the photoconductive member with an electrostatic ink composition to form a developed toner image on the surface of the latent electrostatic image, then transfer the developed toner image to the outer release layer of intermediate transfer member, and then transfer the developed toner image from the outer release layer of the intermediate transfer member to a print substrate.

2. A printing apparatus according to claim 1, wherein the carbon nanotubes comprise single or multi walled carbon nanotubes, at least some of the carbon nanotubes having a diameter in the range of 1 nm to 25 nm.

3. A printing apparatus according to claim 1, wherein the carbon black nanoparticles have a BET surface area of 1000 m²/g or greater.

4. A printing apparatus according to claim 1, wherein at least some of the carbon black nanoparticles have a primary particle diameter of 40 nm or less.

5. A printing apparatus according to claim 1, wherein the outer release layer comprises from 0.01 to 10 wt % carbon nanotubes or carbon black nanoparticles by total weight of the silicone polymer.

6. A printing apparatus according to claim 1, wherein the silicone polymer comprises the cross-linked product of:
at least one silicone oil having alkene groups linked to the silicone chain of the silicone oil;
a cross-linker comprising a silicon hydride component; and
a cross-linking catalyst.

7. A printing apparatus according to claim 6, wherein the silicone oil has the formula (I): 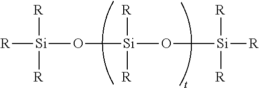
wherein:
each R is independently selected from C₁₋₆ alkyl and C₂₋₆ alkenyl groups, at least two R groups being an alkenyl group; and
t is an integer of at least 1.

8. A printing apparatus according to claim 6, wherein the silicon hydride component comprises a polysiloxane having a silicon hydride moiety.

9. A printing apparatus according to claim 1, wherein the silicone polymer comprises the cross-linked product of:
at least one silicone oil;
a condensation cure cross-linker component; and
a cross-linking catalyst.

10. A printing apparatus according to claim 1, wherein the silicone polymer comprises the cross-linked product of:
at least one silicone oil;
a cross-linker comprising a peroxide component; and
a cross-linking catalyst.

11. A printing apparatus according to claim 1, wherein the silicone polymer comprises the cross-linked product of:
at least one silicone oil;
a photo cross-linker; and
a photo-initiator.

12. A pre-cure release layer composition comprising:
at least one silicone oil;
a cross-linker; and
an additive selected from carbon nanotubes and carbon black nanoparticles, the carbon black nanoparticles having a BET surface area of 700 m²/g or greater.

13. A pre-cure release layer composition according to claim 12, wherein the carbon black nanoparticles have a BET surface area of 1000 m²/g or greater.

14. A pre-cure release layer composition according to claim 12, wherein the composition comprises from 0.01 to 10 wt % carbon nanotubes or carbon black nanoparticles by total weight of the silicone oil.

15. An intermediate transfer member for use in an electrostatic printing process comprising:
a supportive portion; and
an outer release layer disposed on the supportive portion, the outer release layer comprising a base polymer matrix and an additive selected from carbon nanotubes and carbon black nanoparticles, the carbon black nanoparticles having a BET surface area of 700 m²/g or greater,
wherein the additive is dispersed in the base polymer matrix, and the base polymer is a silicone polymer.
